(19) United States
(12) Patent Application Publication
(10) Pub. No.: US 2025/0153662 A1
(43) Pub. Date: May 15, 2025

(54) ROUTING STRUCTURE AND ROUTING METHOD

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/940,722

(22) Filed: Nov. 7, 2024

(30) Foreign Application Priority Data
Nov. 13, 2023 (JP) 2023-192666

(51) Int. Cl. B60R 16/02; B60J 7/043; H02G 1/06; H02G 11/00

(52) U.S. Cl. CPC B60R 16/0215; H02G 1/06; H02G 11/00; B60J 7/043

(57) ABSTRACT

A routing structure includes: an exterior member having a first fixing part; a second fixing part; a first end portion held by the first fixing part and a second end portion held by the second fixing part; an electric wire inserted through the exterior member; and a holding part holding the electric wire, in which the first fixing part and the second fixing part hold the exterior member to form a curved portion in which the exterior member is curved in a vehicle front-rear direction between the first end portion and the second end portion, and the holding part holds at least two portions of the electric wire such that the electric wire has an extra length retaining portion inside the exterior member.

### CROSS-REFERENCE TO RELATED APPLICATION(S)

The present application claims priority to and incorporates by reference the entire contents of Japanese Patent Application No. 2023-192666 filed in Japan on Nov. 13, 2023.

### BACKGROUND OF THE INVENTION

### 1. Field of the Invention

The present invention relates to a routing structure and a routing method.

### 2. Description of the Related Art

Conventionally, there is a power feeding device for a slide body. Japanese Patent Application Laid-open No. 2011-151906 discloses a power feeding device for a slide body including a wire harness routed over a vehicle body and a slide body that is slidably provided on the vehicle body and opens and closes an opening formed in the vehicle body.

Here, when an electric wire is curved in a narrow space between the vehicle body and the slide body, the durability of the electric wire against bending is easily affected. In the electric wire routed between the vehicle body and the slide body, it is desirable to suppress a decrease in durability against bending.

### SUMMARY OF THE INVENTION

An object of the present invention is to provide a routing structure and a routing method capable of suppressing a decrease in durability of an electric wire against bending.

In order to achieve the above mentioned object, a routing structure according to one aspect of the present invention includes a first fixing part fixed to a vehicle body of a vehicle; a second fixing part fixed to a slide body that moves along a vehicle front-rear direction with respect to an opening provided in a roof of the vehicle body; an exterior member having a first end portion held by the first fixing part and a second end portion held by the second fixing part; an electric wire inserted through the exterior member; and a holding part holding the electric wire, wherein the first fixing part and the second fixing part hold the exterior member to form a curved portion in which the exterior member is curved in the vehicle front- rear direction between the first end portion and the second end portion, and the holding part holds at least two portions of the electric wire such that the electric wire has an extra length retaining portion inside the exterior member.

In order to achieve the above mentioned object, a routing method according to another aspect of the present invention includes a step of elastically deforming a plate-like biasing member, and supporting the biasing member deformed into a shape having a curved portion with a jig; a step of routing an electric wire with respect to the biasing member supported by the jig; and a step of fixing the electric wire to at least two portions of the biasing member with holding parts, wherein in the routing step, the electric wire is routed with respect to an outer surface of the curved portion of the biasing member, and in the fixing step, both sides of a portion of the electric wire that extends along the curved portion are fixed to the biasing member by the holding parts.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a plan view of an electric wire having an extra length retaining portion;

FIG. 6 is a view illustrating an electric wire positioned in a curved portion of an exterior member;

FIG. 7 is a perspective view illustrating an electric wire assembly manufactured on a jig;

FIG. 8 is a plan view illustrating the jig according to the present embodiment;

FIG. 9 is a plan view illustrating a biasing member supported by the jig;

FIG. 10 is a plan view illustrating an electric wire routed along the biasing member;

FIG. 11 is a plan view of an electric wire having an extra length retaining portion; and

FIG. 12 is a side view illustrating holding parts disposed on fixing parts.

### DETAILED DESCRIPTION OF THE PREFERRED EMBODIMENTS

Hereinafter, a routing structure and a routing method according to an embodiment of the present invention will be described in detail with reference to the drawings. Note that the present invention is not limited by the present embodiment. In addition, the components in the following embodiment include those that can be easily imagined by those skilled in the art or those that are substantially the same.

### Embodiment

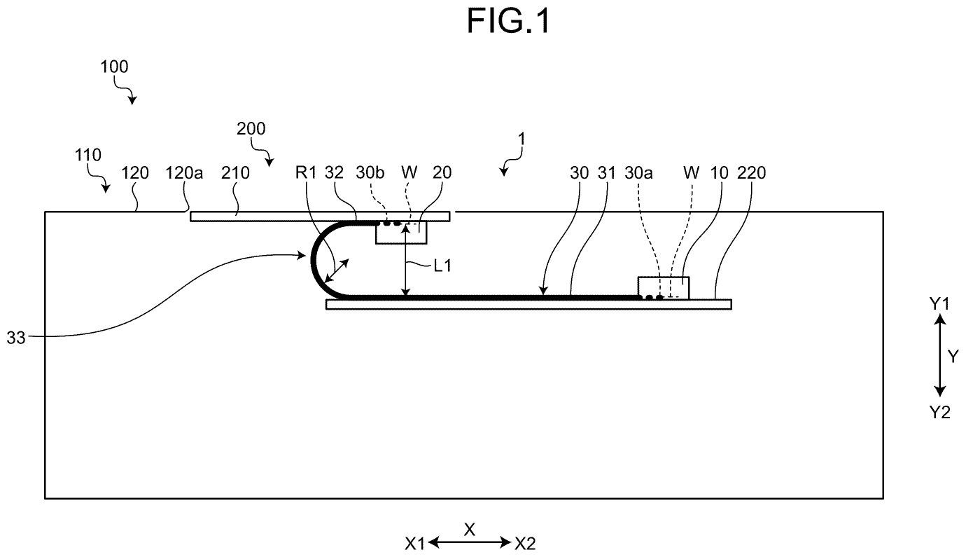

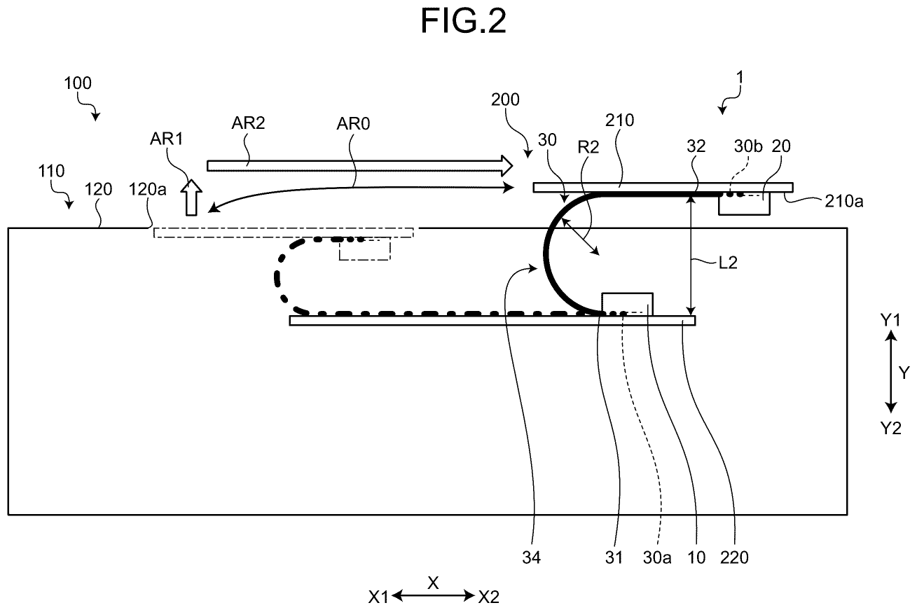

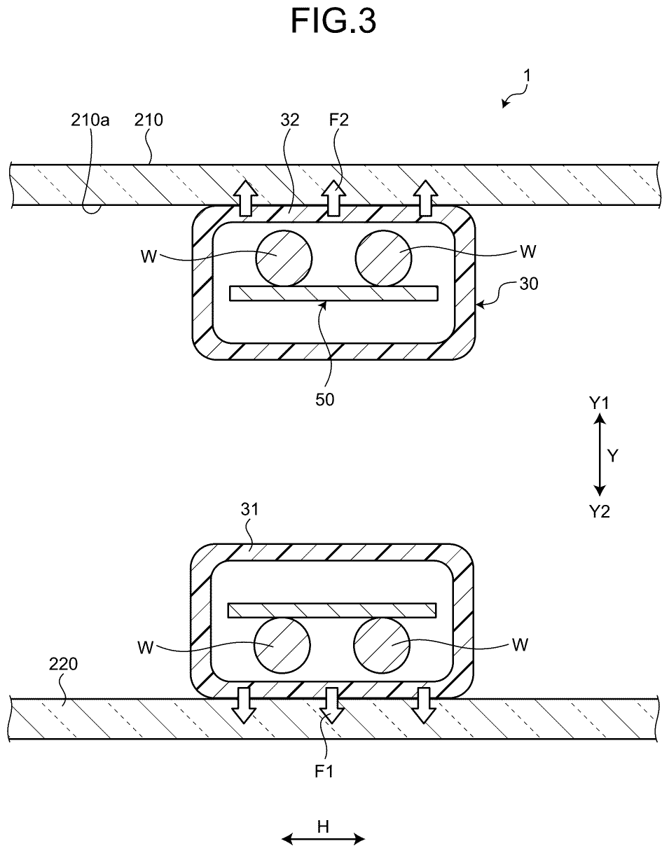

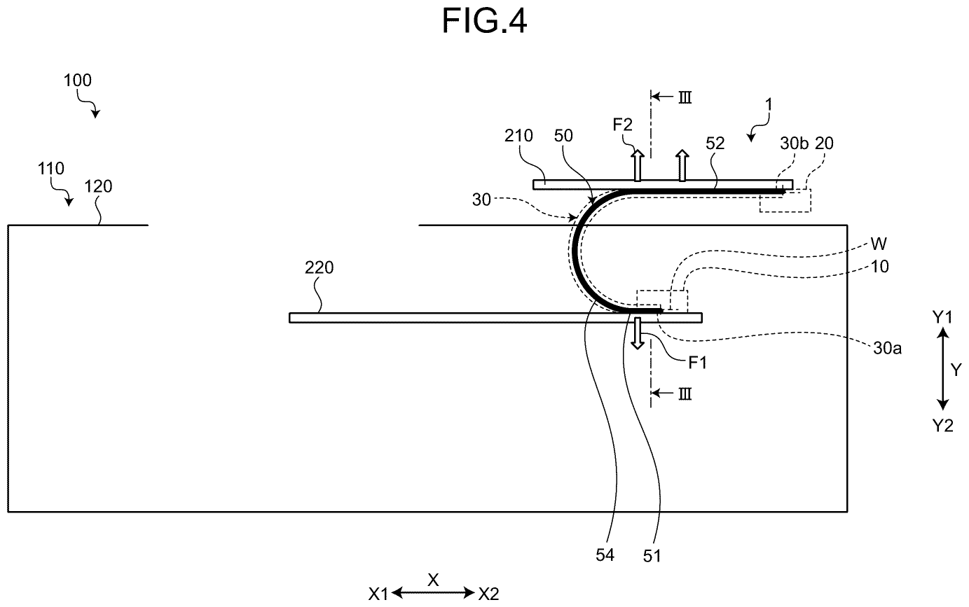

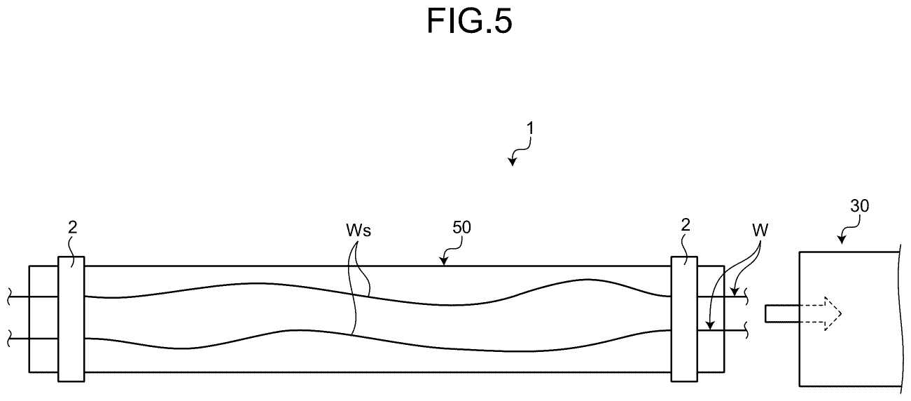

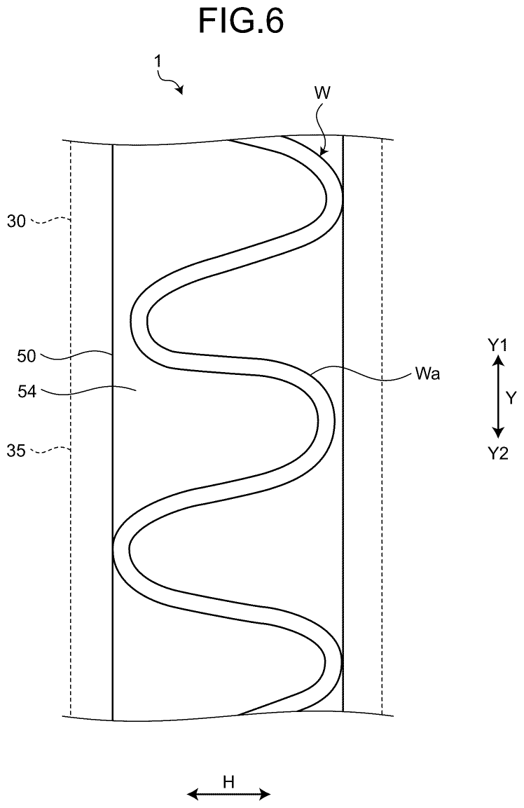

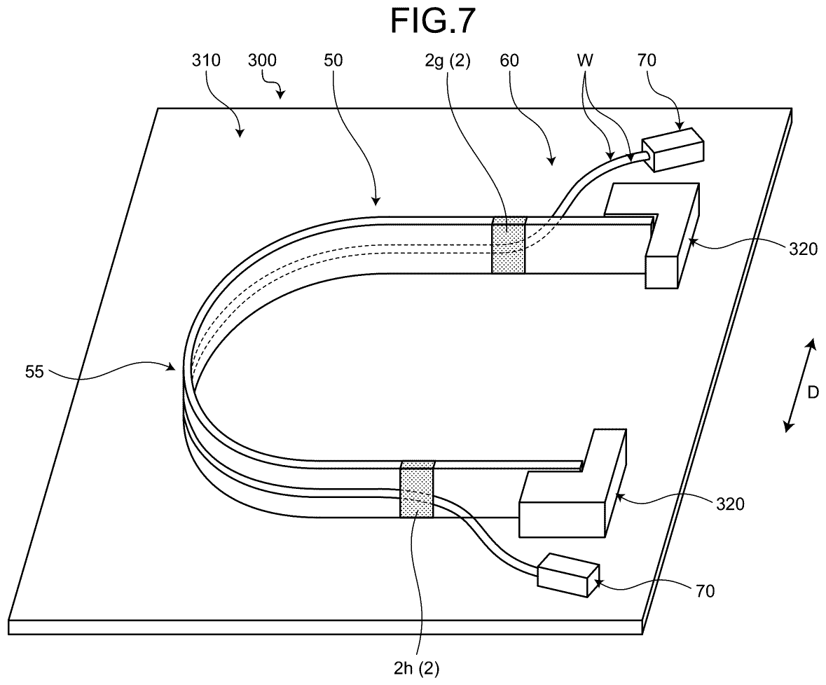

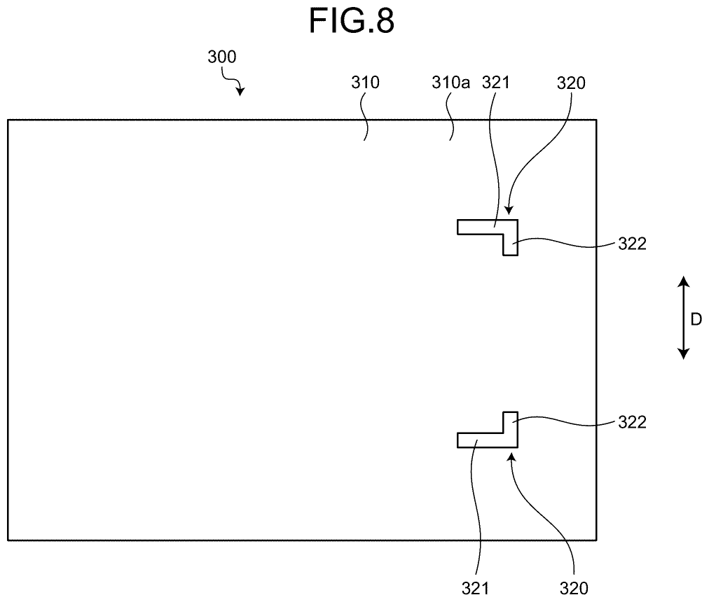

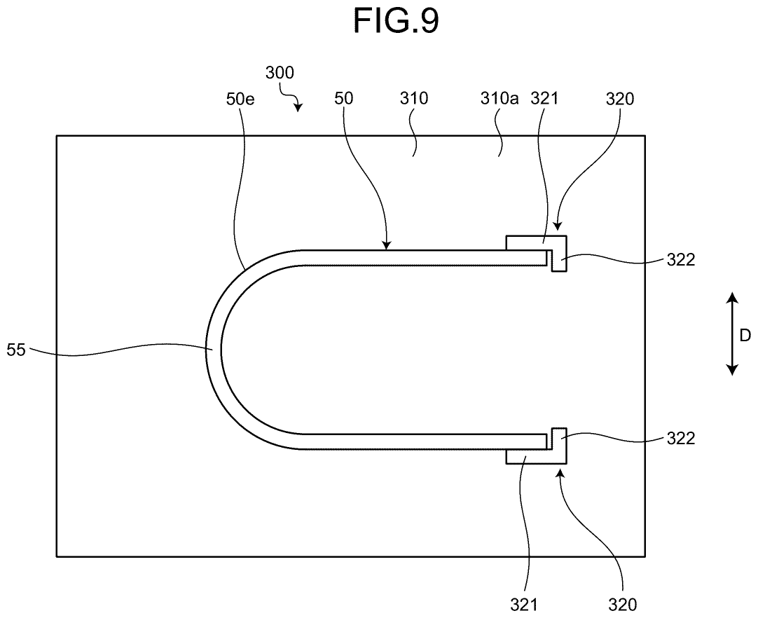

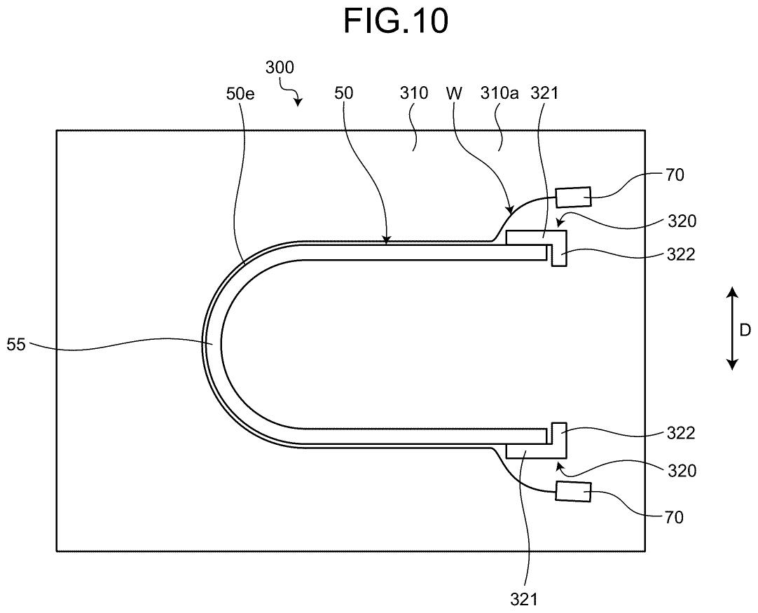

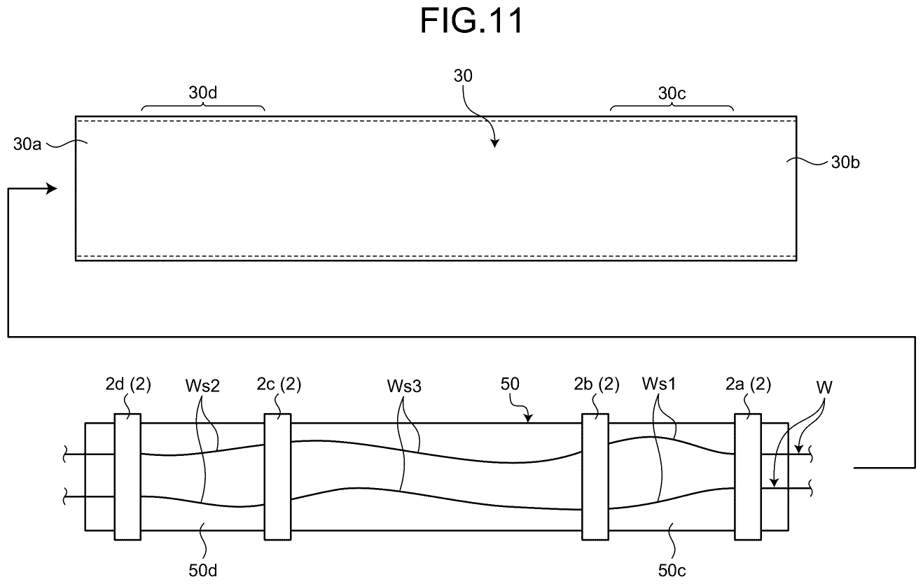

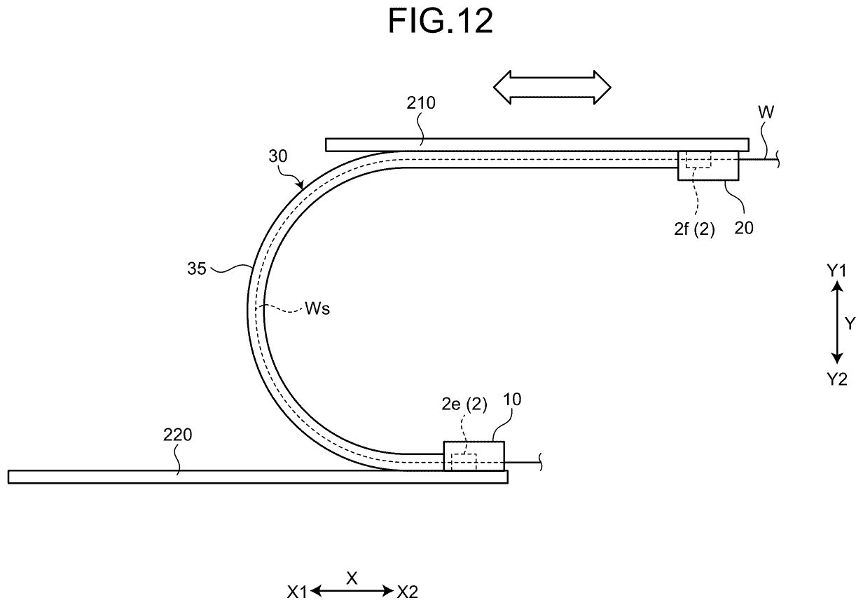

An embodiment will be described with reference to FIGS. 1 to 12. The present embodiment relates to a routing structure and a routing method. FIGS. 1 and 2 are side views of the routing structure according to the embodiment, FIG. 3 is a cross-sectional view of the routing structure according to the embodiment, FIG. 4 is a side view of the routing structure according to the embodiment, FIG. 5 is a plan view of an electric wire having an extra length retaining portion, FIG. 6 is a view illustrating an electric wire positioned in a curved portion of an exterior member, FIG. 7 is a perspective view illustrating an electric wire assembly manufactured on a jig, FIG. 8 is a plan view illustrating the jig according to the present embodiment, FIG. 9 is a plan view illustrating a biasing member supported by the jig, FIG. 10 is a plan view illustrating an electric wire routed along the biasing member, FIG. 11 is a plan view of an electric wire having an extra length retaining portion, and FIG. 12 is a side view illustrating holding parts disposed on fixing parts. FIG. 3 illustrates a cross section taken along line III-III in FIG. 4.

As illustrated in FIG. 1, a routing structure 1 according to the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 has a roof 120 that covers the vehicle interior. The roof 120 has an opening 120a that is open upward.

The vehicle 100 includes a sunroof 200 that opens and closes the opening 120a. The sunroof 200 has a slide body 210, a rail 220, and a routing structure 1. The slide body 210 is a member that slides along a vehicle front-rear direction X with respect to the opening 120a. The slide body 210 according to the present embodiment is a plate-like member that closes the opening 120a or opens the opening 120a. The slide body 210 may be glass configured to allow light to be transmitted therethrough.

The sunroof 200 includes a mechanism such as a link mechanism that moves the slide body 210 along a predetermined path, and a drive source such as a motor that operates the above mechanism. The sunroof 200 moves the slide body 210 between a fully closed position where the opening 120a is closed and a fully opened position where the opening 120a is opened. FIG. 1 illustrates the slide body 210 at the fully closed position. FIG. 2 illustrates the slide body 210 at the fully opened position.

The rail 220 is fixed to the vehicle body 110. The rail 220 extends in the vehicle front-rear direction X. The rail 220 supports the mechanism for moving the slide body 210, and guides the mechanism in the vehicle front-rear direction X. The rail 220 further supports an exterior member 30, and forms a first extending portion 31 on the exterior member 30.

The sunroof 200 according to the present embodiment moves the slide body 210 along a path AR0 illustrated in FIG. 2. The movement of the slide body 210 along the path AR0 includes a movement along the vehicle front-rear direction X and a movement along a vehicle up-down direction Y. When the slide body 210 moves from the fully closed position toward the fully opened position, the slide body 210 moves toward an upper side Y1 in the vehicle up-down direction Y and moves toward a rear side X2 in the vehicle front-rear direction X as indicated by an arrow AR1 in FIG. 2.

Conversely, when the slide body 210 moves from the fully opened position to the fully closed position, the slide body 210 moves toward a front side X1 in the vehicle front-rear direction X and moves toward a lower side Y2 in the vehicle up-down direction Y.

As illustrated in FIGS. 1 to 3, the routing structure 1 includes a first fixing part 10, a second fixing part 20, an exterior member 30, an electric wire W, and a biasing member 50. The exterior member 30 and the electric wire W constitute a wire harness routed between the vehicle body 110 and the slide body 210.

The first fixing part 10 is a member fixed to the vehicle body 110 of the vehicle 100. The first fixing part 10 may be a protector that protects the electric wire W. The first fixing part 10 is molded from, for example, an insulating synthetic resin. The first fixing part 10 has a space in which the electric wire W is routed and has a holding structure for holding the exterior member 30.

The second fixing part 20 is a member fixed to the slide body 210 of the sunroof 200. The second fixing part 20 may be a protector that protects the electric wire W. The second fixing part 20 is molded from for example, an insulating synthetic resin. The second fixing part 20 has a space in which the electric wire W is routed and has a holding structure for holding the exterior member 30.

The exterior member 30 is an elastically deformable tubular member. The exterior member 30 is, for example, a member called a corrugated tube. The exterior member 30 is molded from, for example, an insulating synthetic resin. The exterior member 30 may have a bellows shape.

The exterior member 30 has a first end portion 30a held by the first fixing part 10 and a second end portion 30b held by the second fixing part 20. The first fixing part 10 holds the first end portion 30a such that the exterior member 30 extends from the first fixing part 10 along the rail 220 in the vehicle front-rear direction X. The first fixing part 10 according to the present embodiment holds the first end portion 30a such that the exterior member 30 extends from the first fixing part 10 toward the front side X1.

The second fixing part 20 holds the second end portion 30b such that the exterior member 30 extends from the second fixing part 20 along the slide body 210 in the vehicle front-rear direction X. The second fixing part 20 according to the present embodiment holds the second end portion 30b such that the exterior member 30 extends from the second fixing part 20 toward the front side X1.

The electric wire W and the biasing member 50 are inserted through the exterior member 30. The electric wire W is, for example, a sheathed electric wire having a stranded wire and a sheath. The electric wire W may be a flat routing material, a printed circuit body, or another circuit body. The electric wire W drawn out from the first end portion 30a is connected to a power supply and a control device disposed in the vehicle body 110. The electric wire W drawn out from the second end portion 30b is connected to a load disposed on the slide body 210. The load disposed on the slide body 210 may be, for example, a lighting device, a light control film disposed on the glass of the slide body 210, or another electric load.

As illustrated in FIGS. 1 and 2, the exterior member 30 has a curved portion 33 or 34 that is curved in the vehicle front-rear direction X between the first end portion 30a and the second end portion 30b. The curved portion 33 or 34 is formed by the biasing member 50. The curved portion 33 illustrated in FIG. 1 is a curved portion formed in the exterior member 30 in a state where the slide body 210 is at the fully closed position. The curved portion 33 has a radius R1. The curved portion 34 illustrated in FIG. 2 is a curved portion formed in the exterior member 30 in a state where the slide body 210 is at the fully opened position. The curved portion 34 has a radius R2. The electric wire W in which the curved portion 33 or 34 is formed has a U shape or a J shape.

As illustrated in FIG. 1, when the slide body 210 is at the fully closed position, a distance of the second end portion 30b from the first end portion 30a in the vehicle up-down direction Y is a first distance L1. The radius R1 of the curved portion 33 is half the first distance L1.

As illustrated in FIG. 2, when the slide body 210 is at the fully opened position, a distance of the second end portion 30b from the first end portion 30a in the vehicle up-down direction Y is a second distance L2. The radius R2 of the curved portion 34 is half the second distance L2.

In the sunroof 200 according to the present embodiment, the second distance L2 at the fully opened position is larger than the first distance L1 at the fully closed position. Accordingly, the radius R1 of the curved portion 33 when the slide body 210 is at the fully closed position is smaller than the radius R2 of the curved portion 34 when the slide body 210 is at the fully opened position. In addition, the radius R1 when the slide body 210 is at the fully closed position is smaller than a radius of a curved shape formed in the biasing member 50 when the slide body 210 is at another position. In other words, the curved shape formed in the biasing member 50 has a smallest radius when the slide body 210 is at the fully closed position.

The second end portion 30b of the exterior member 30 moves together with the slide body 210. At this time, the exterior member 30 follows the movement of the second fixing part 20 while gradually changing the position where the curved shape is formed.

The biasing member 50 according to the present embodiment is a member that presses the exterior member 30 toward the slide body 210. The biasing member 50 according to the present embodiment is a plate-like member, and is elastically deformable. The biasing member 50 is formed of a metal or a resin.

As illustrated in FIG. 3, the exterior member 30 according to the present embodiment has a rectangular cross-sectional shape. The exemplified shape of the biasing member 50 is a flat plate shape. In the biasing member 50, a cross-sectional shape orthogonal to an axial direction of the biasing member 50 is rectangular. The biasing member 50 extends from one end to the other end in a width direction H in the internal space of the exterior member 30. The biasing member 50 faces each of a plurality of electric wires W in the vehicle up-down direction Y. In other words, the biasing member 50 has a width capable of supporting the plurality of electric wires W.

The biasing member 50 in FIG. 3 is disposed inside the electric wire W. Therefore, in the curved portion 33 or 34, the biasing member 50 is positioned inside the electric wire W in a radial direction. As illustrated in FIG. 3, the biasing member 50 applies pressing forces F1 and F2 to the exterior member 30 via the electric wire W.

As illustrated in FIG. 4, the exterior member 30, the electric wire W, and the biasing member 50 are routed in a curved state in a U shape or a J shape. That is, the biasing member 50 extends from the first fixing part 10 to the second fixing part 20 with a curved portion 54.

The biasing member 50 bent to have the curved portion 54 applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the slide body 210. The pressing forces F1 and F2 are restoring forces generated in the bent biasing member 50.

The pressing force F1 forms a first extending portion 31 in the exterior member 30. The pressing force F2 forms a second extending portion 32 in the exterior member 30. As illustrated in FIG. 2, etc., the second extending portion 32 is a portion extending along a vehicle interior side surface 210a of the slide body 210. The vehicle interior side surface 210a is a surface facing the lower side Y2. When the vehicle interior side surface 210a is a flat surface, the second extending portion 32 is formed straight. When the vehicle interior side surface 210a has a curved shape, the second extending portion 32 has a curved shape along the vehicle interior side surface 210a.

The biasing member 50 according to the present embodiment is configured to press the exterior member 30 toward the slide body 210 both when the slide body 210 is at the fully closed position and when the slide body 210 is at the fully opened position. In other words, the biasing member 50 has rigidity capable of pressing the exterior member 30 against and in contact with the slide body 210 at all times. Therefore, the routing structure 1 according to the present embodiment can stabilize the shape of the exterior member 30. The biasing member 50 can keep the exterior member 30 in contact with the slide body 210 against an external force such as a vibration generated, for example, during traveling.

As will be described below, the routing structure 1 according to the present embodiment is configured such that the electric wire W has an extra length retaining portion Ws inside the exterior member 30. FIG. 5 illustrates the electric wire W and the biasing member 50 before being inserted through the exterior member 30. The biasing member 50 before being inserted through the exterior member 30 has a flat plate shape. The electric wire W is held by a holding part 2 to have the extra length retaining portion Ws. The holding part 2 of FIG. 5 holds the electric wire W by fixing the electric wire W to the biasing member 50. The holding part 2 holds the electric wire W by fixing at least two portions of the electric wire W to the biasing member 50.

The holding part 2 is, for example, a member capable of fixing the electric wire W to the biasing member 50, such as an adhesive tape or a binding band. The two holding parts 2 in FIG. 5 fix the electric wire W to both end portions of the biasing member 50. A length of the extra length retaining portion Ws in the electric wire W is greater than a length L between the two holding parts 2 in the biasing member 50. Therefore, the extra length retaining portion Ws can extend while being curved along the biasing member 50 between the two holding parts 2. The extra length retaining portion Ws according to the present embodiment is a portion having an extra length with respect to the exterior member 30 and the biasing member 50. That is, the extra length retaining portion Ws is a meanderable portion having a length enough to meander inside the exterior member 30.

The biasing member 50 and the electric wire W fixed to the biasing member 50 are inserted through the exterior member 30. The exterior member 30 and the biasing member 50 are held by the first fixing part 10 and the second fixing part 20. As a result, the curved portion 54 is formed in the biasing member 50, and a curved shape corresponding to the curved portion 54 is formed in the exterior member 30.

FIG. 6 illustrates the electric wire W positioned in a curved portion 35 of the exterior member 30. The curved portion 35 is a curved portion formed by the curved portion 54 of the biasing member 50. The curved portion 35 may be a curved portion 33 when the slide body 210 is at the fully closed position, a curved portion 34 when the slide body 210 is at the fully opened position, or a curved portion when the slide body 210 is at another position.

Since the electric wire W has the extra length retaining portion Ws inside the exterior member 30, excessive stress is hardly generated on the electric wire W in the curved portion 35. The electric wire W having the extra length retaining portion Ws extends while being curved inside the exterior member 30. In this case, the electric wire W forms, for example, a meandering shape inside the exterior member 30. The electric wire illustrated in FIG. 6 forms a meandering portion Wa meandering along a support surface of the biasing member 50 inside the exterior member 30. When the exterior member 30 forms the curved portion 35, bending deformation and twisting deformation occur in the electric wire W having the extra length retaining portion Ws.

As a comparative example, in a case where the electric wire W does not have the extra length retaining portion Ws, when the exterior member 30 is deformed, bending deformation mainly corresponding to the curved portion 35 occurs in the electric wire W. On the other hand, in the electric wire W according to the present embodiment having the extra length retaining portion Ws, not only bending deformation but also twisting deformation occur. This reduces the stress generated on the electric wire W when following the deformation of the exterior member 30, and improves the durability of the electric wire W against bending. In addition, in a case where the electric wire W has the extra length retaining portion Ws, an excessive tensile force hardly acts on the electric wire W when the curved portion 35 is formed. Therefore, the durability of the electric wire W is improved.

A routing method of routing the electric wire W with respect to the biasing member 50 will be described with reference to FIGS. 7 to 10. In FIG. 7, an electric wire assembly 60 manufactured on a jig 300 is illustrated. The electric wire assembly 60 includes the biasing member 50, the electric wire W, and the plurality of holding parts 2. Connectors 70 are connected to both ends of the electric wire W. The electric wire assembly 60 is inserted into the exterior member 30, and attached to the vehicle body 110 together with the exterior member 30.

As illustrated in FIGS. 7 and 8, the jig 300 includes a plate-like main body 310 and a pair of support portions 320. The main body 310 has, for example, a rectangular shape. The support portions 320 support the biasing member 50 in a curved state. The support portion 320 protrudes from a support surface 310a of the main body 310 in a direction orthogonal to the support surface 310a.

The support portion 320 has a substantially L shape in plan view. The pair of support portions 320 face each other in a width direction D of the main body 310. The support portion 320 has a support wall 321 and an opposing wall 322. The support wall 321 is a portion that supports an end portion of the biasing member 50, and extends in a direction orthogonal to the width direction D. The opposing wall 322 protrudes in the width direction D with respect to the support wall 321. The opposing wall 322 faces a distal end surface of the biasing member 50.

The routing method for routing the electric wire W to the biasing member 50 using the jig 300 includes an installation step, a routing step, and a fixing step. The installing step is a step of supporting the biasing member 50 by the jig 300. As illustrated in FIG. 9, the biasing member 50 is set on the jig 300 in an elastically deformed state to form a substantially U shape.

In the installation step, a worker elastically deforms the biasing member 50 to have an arcuate curved portion 55. The worker causes the biasing member 50 deformed into a shape having the curved portion 55 to be supported by the jig 300. Both end portions of the biasing member 50 are supported by the pair of support portions 320. The biasing member 50 is placed on the support surface 310a so that an end portion thereof is aligned with the support wall 321. One end portion of the biasing member 50 is supported by one support wall 321. The other end portion of the biasing member 50 is supported by the other support wall 321. The two support walls 321 support the biasing member 50 from both sides in the width direction D, and maintain the shape of the biasing member 50 in a U shape. The biasing member 50 supported by the jig 300 has an outer surface 50e. The outer surface 50e is an outer surface in the radial direction in the curved portion 55. In other words, the outer surface 50e is one of the two main surfaces of the biasing member 50 located on the outer side in the curved portion 55.

The routing step is a step of routing an electric wire W with respect to the biasing member 50 supported by the jig 300. In the routing step, the worker routes the electric wire W along the biasing member 50 from one end of the biasing member 50 to the other end of the biasing member 50. As illustrated in FIG. 10, the electric wire W is disposed along the outer surface 50e of the biasing member 50. Therefore, the electric wire W is located outside the curved portion 55 in the radial direction.

The fixing step is a step of fixing the electric wire W to the biasing member 50. The worker fixes the electric wire W to at least two portions of the biasing member 50 using holding parts 2. The holding parts 2 are disposed on both sides of a portion of the electric wire W that extends along the curved portion 55. The electric wire assembly 60 of FIG. 7 has a holding part 2g disposed on one side with respect to the curved portion 55 and a holding part 2h disposed on the other side with respect to the curved portion 55. The holding parts 2g and 2h are disposed near the end portions of the biasing member 50. The holding parts 2g and 2h are, for example, adhesive tapes, binding bands, or the like.

When the biasing member 50 is removed from the jig 300, the shape of the biasing member 50 becomes straight. As a result, as illustrated in FIG. 5, an extra length retaining portion Ws is formed in the electric wire W. According to the routing method using the jig 300, the length of the extra length retaining portion Ws can be set to an appropriate length. Note that, when the electric wire W is routed with respect to the biasing member 50 supported by the jig 300, an extra length may be given to the length of the electric wire W that extends along the biasing member 50. That is, the electric wire W may be routed such that the length of the electric wire W that extends along the outer surface 50e is greater than the length of the outer surface 50e.

The holding parts 2 may hold the electric wire W in such a manner as to locate the extra length retaining portion Ws at a predetermined position of the exterior member 30. The electric wire W illustrated in FIG. 11 includes a first retaining portion Ws1 and a second retaining portion Ws2 as the extra length retaining portion Ws. The first retaining portion Ws1 is formed to be positioned in the curved portion 33 when the slide body 210 is at the fully closed position. The second retaining portion Ws2 is formed to be positioned in the curved portion 34 when the slide body 210 is at the fully opened position.

The exterior member 30 has a first portion 30c that forms the curved portion 33 in the fully closed state and a second portion 30d that forms the curved portion 34 in the fully opened state. The first portion 30c is located near the second end portion 30b. The second portion 30d is located near the first end portion 30a. The biasing member 50 includes a first portion 50c corresponding to the first portion 30c of the exterior member 30 and a second portion 50d corresponding to the second portion 30d of the exterior member 30.

The holding parts 2 includes a first holding part 2a, a second holding part 2b, a third holding part 2c, and a fourth holding part 2d. The first holding part 2a and the second holding part 2b form the first retaining portion Ws1 in the first portion 50c. The first holding part 2a is disposed at one end of the first portion 50c to fix the electric wire W to the biasing member 50. The second holding part 2b is disposed at the other end of the first portion 50c to fix the electric wire W to the biasing member 50.

The third holding part 2c and the fourth holding part 2d form the second retaining portion Ws2 in the second portion 50d. The third holding part 2c is disposed at one end of the second portion 50d to fix the electric wire W to the biasing member 50. The fourth holding part 2d is disposed at the other end of the second portion 50d to fix the electric wire W to the biasing member 50.

The length of the first retaining portion Ws1 is determined, for example, based on the value of the radius R1 of the curved portion 33 and the position of the electric wire W with respect to the biasing member 50. The length of the first retaining portion Ws1 may be determined, for example, depending on which one of the inner side and the outer side in the radial direction the electric wire W is disposed on with respect to the biasing member 50. In a case where the electric wire W is disposed outside the biasing member 50, the length of the first retaining portion Ws1 may be greater than that in a case where the electric wire W is disposed inside the biasing member 50.

The length of the second retaining portion Ws2 is determined, for example, based on the value of the radius R2 of the curved portion 34 and the position of the electric wire W with respect to the biasing member 50. In a case where the electric wire W is disposed outside the biasing member 50, the length of the second retaining portion Ws2 may be greater than that in a case where the electric wire W is disposed inside the biasing member 50.

In the sunroof 200 according to the present embodiment, the radius R1 in the fully closed state is smaller than the radius R2 in the fully opened state. In this case, the length of the first retaining portion Ws1 may be set to a value greater than the length of the second retaining portion Ws2.

The electric wire W of FIG. 11 includes a third retaining portion Ws3 that is an extra length retaining portion Ws between the first retaining portion Ws1 and the second retaining portion Ws2. That is, the second holding part 2b and the third holding part 2c hold the electric wire W in such a manner as to form the third retaining portion Ws3 between the two holding parts 2b and 2c. In a case where a plurality of extra length retaining portions Ws are formed as described above, uneven distribution of the extra length retaining portions Ws is suppressed.

Note that the holding parts 2 is not limited to those that fix the electric wire W to the biasing member 50. For example, the holding parts 2 may hold the electric wire W on the fixing parts 10 and 20. FIG. 12 illustrates a holding part 2e disposed on the first fixing part 10 and a holding part 2f disposed on the second fixing part 20. The holding part 2e may be a clamp integrally provided on the first fixing part 10. The holding part 2f may be a clamp integrally provided on the second fixing part 20. These clamps can hold the electric wire W, and form an extra length retaining portion Ws inside the exterior member 30.

The holding part 2e may be an adhesive tape, a binding band, or the like that fixes the electric wire W to a holding member of the first fixing part 10. The holding part 2f may be an adhesive tape, a binding band, or the like that fixes the electric wire W to a holding member of the second fixing part 20.

The holding parts 2e and 2f hold the electric wire W in such a manner that the electric wire W has an extra length retaining portion Ws inside the exterior member 30. That is, the holding parts 2e and 2f hold the electric wire W such that the length of the electric wire W accommodated inside the exterior member 30 is greater than the length of the exterior member 30.

In a case where the holding parts 2e and 2f are disposed on the fixing parts 10 and 20, the routing structure 1 may include no biasing member 50. In addition, in a case where the routing structure 1 includes the biasing member 50, the holding parts 2e and 2f may be disposed on the fixing parts 10 and 20. In this case, the electric wire W may not be fixed to the biasing member 50.

As described above, the routing structure 1 according to the present embodiment includes the first fixing part 10, the second fixing part 20, the exterior member 30, the electric wire W, and the holding part 2. The first fixing part 10 is fixed to the vehicle body 110 of the vehicle 100. The second fixing part 20 is fixed to the slide body 210. The slide body 210 moves along the vehicle front-rear direction X with respect to the opening 120a provided in the roof 120 of the vehicle body 110. The exterior member 30 has the first end portion 30a held by the first fixing part 10 and the second end portion 30b held by the second fixing part 20. The electric wire W is inserted through the exterior member 30. The holding part 2 holds the electric wire W.

The first fixing part 10 and the second fixing part 20 hold the exterior member 30 to form the curved portion 35 in which the exterior member 30 is curved in the vehicle front-rear direction X between the first end portion 30a and the second end portion 30b. The holding part 2 holds at least two portions of the electric wire W so that the electric wire W has the extra length retaining portion Ws inside the exterior member 30. Since the electric wire W has the extra length retaining portion Ws inside the exterior member 30, stress generated on the electric wire W is reduced when the exterior member 30 is deformed. As a result, the routing structure 1 according to the present embodiment can improve the durability of the electric wire W against bending.

The routing structure 1 may include the biasing member 50 inserted through the exterior member 30. The holding part 2 fixes the electric wire W to the biasing member 50, so that the extra length retaining portion Ws can be formed in the electric wire W along the biasing member 50. With such a configuration, the extra length retaining portion Ws can be located at a target position inside the exterior member 30.

The holding part 2 may be disposed on each of the first fixing part 10 and the second fixing part 20. In this case, the holding part 2e of the first fixing part 10 and the holding part 2f of the second fixing part 20 hold the electric wire W such that the electric wire W has the extra length retaining portion Ws inside the exterior member 30. With such a configuration, the extra length retaining portion Ws can be disposed over the entire length of the exterior member 30.

The slide body 210 according to the present embodiment moves in the vehicle front-rear direction X between a fully closed position where the opening 120a is closed and a fully opened position where the opening 120a is opened. The holding part 2 may hold the electric wire W such that the extra length retaining portion Ws is positioned in the curved portion 33 when the slide body 210 is at the fully closed position. The first holding part 2a and the second holding part 2b in FIG. 11 form a first retaining portion Ws1 located in the curved portion 33. The holding part 2 may hold the electric wire such that the extra length retaining portion Ws is positioned in the curved portion 34 when the slide body 210 is at the fully opened position. The third holding part 2c and the fourth holding part 2d in FIG. 11 form a second retaining portion Ws2 located in the curved portion 34.

The holding part 2 illustrated in FIG. 11 forms both the first retaining portion Ws1 and the second retaining portion Ws2, but the holding part 2 may form only one of the first retaining portion Ws1 and the second retaining portion Ws2.

A routing method according to the present embodiment includes an installation step, a routing step, and a fixing step. The installation step is a step of elastically deforming the plate-like biasing member 50 and supporting the biasing member 50 deformed into a shape having the curved portion 55 with the jig 300. The routing step is a step of routing an electric wire W with respect to the biasing member 50 supported by the jig 300. The fixing step is a step of fixing the electric wire W to at least two portions of the biasing member 50 with the holding parts 2. In the routing step, the electric wire W is routed with respect to the outer surface 50e of the curved portion 55 of the biasing member 50. In the fixing step, both sides of a portion of the electric wire W that extends along the curved portion 55 are fixed to the biasing member 50 by the holding parts 2. The routing method according to the present embodiment is capable of forming the appropriate extra length retaining portion Ws.

The embodiments disclosed above can be carried out in an appropriate combination.

In the routing structure according to the present embodiment, the holding part holds at least two portions of the electric wire so that the electric wire has an extra length retaining portion inside the exterior member. The routing structure according to the present embodiment is advantageous in that a decrease in durability of the electric wire against bending can be suppressed.

The routing method according to the present embodiment is advantageous in that an extra length retaining portion can be appropriately formed along the biasing member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixing part fixed to a vehicle body of a vehicle;
a second fixing part fixed to a slide body that moves along a vehicle front-rear direction with respect to an opening provided in a roof of the vehicle body;
an exterior member having a first end portion held by the first fixing part and a second end portion held by the second fixing part;
an electric wire inserted through the exterior member; and
a holding part holding the electric wire, wherein
the first fixing part and the second fixing part hold the exterior member to form a curved portion in which the exterior member is curved in the vehicle front-rear direction between the first end portion and the second end portion, and
the holding part holds at least two portions of the electric wire such that the electric wire has an extra length retaining portion inside the exterior member.

2. The routing structure according to claim 1, further comprising:
a biasing member inserted through the exterior member, wherein
the holding part fixes the electric wire to the biasing member, so that the extra length retaining portion is formed in the electric wire along the biasing member.

3. The routing structure according to claim 1, wherein
the holding part is disposed on each of the first fixing part and the second fixing part, and
the holding part of the first fixing part and the holding part of the second fixing part hold the electric wire such that the electric wire has the extra length retaining portion inside the exterior member.

4. The routing structure according to claim 1, wherein
the slide body moves in the vehicle front-rear direction between a fully closed position where the opening is closed and a fully opened position where the opening is opened, and
the holding part holds the electric wire such that the extra length retaining portion is positioned in the curved portion when the slide body is at the fully closed position, or holds the electric wire such that the extra length retaining portion is positioned in the curved portion when the slide body is at the fully opened position.

5. A routing method comprising:
a step of elastically deforming a plate-like biasing member, and supporting the biasing member deformed into a shape having a curved portion with a jig;
a step of routing an electric wire with respect to the biasing member supported by the jig; and
a step of fixing the electric wire to at least two portions of the biasing member with holding parts, wherein
in the routing step, the electric wire is routed with respect to an outer surface of the curved portion of the biasing member, and
in the fixing step, both sides of a portion of the electric wire that extends along the curved portion are fixed to the biasing member by the holding parts.
